(19) United States
(12) Patent Application Publication
(10) Pub. No.: US 2025/0155861 A1
(43) Pub. Date: May 15, 2025

(54) METHOD FOR PREDICTING ELECTRIC ENERGY CONSUMPTION IN AN ELECTRIC GRID

(71) Applicant: ABB S.p.A, Milano (IT)

(72) Inventors: Marco Lauricella, Mannheim (DE); Giulia Mandelli, Torre Boldone (BG) (IT); Lorenzo Fenili, Valbrembo (IT)

(21) Appl. No.: 18/946,350

(22) Filed: Nov. 13, 2024

(30) Foreign Application Priority Data
Nov. 15, 2023 (EP) 23210163.4

(51) Int. Cl. G05B 19/042

(52) U.S. Cl. CPC G05B 19/042; G05B 2219/2639

(57) ABSTRACT

A method for predicting electric energy consumption in an electric grid, which employs a linear auto-regressive model to calculate prediction data related to the electric energy consumption in an electric grid. The prediction method ensures high level performances in terms of prediction accuracy and it can be easily implemented even when limited computational and data storage resources are available.

### CROSS-REFERENCE TO RELATED APPLICATIONS

The present application claims priority to European Patent Application No. 23210163.4, filed on Nov. 15, 2023, and titled “A METHOD FOR PREDICTING ELECTRIC ENERGY CONSUMPTION IN AN ELECTRIC GRID”, which is hereby incorporated by reference in its entirety.

### TECHNICAL FIELD

The present disclosure relates to the field of electric power distribution grids. More particularly, the present disclosure relates to a method for predicting electric energy consumption in an electric grid.

### BACKGROUND

As is known, the management of electric grids generally requires an accurate prediction activity of the electric energy consumption to allow system operators to properly plan the use of electric energy over time, thereby preventing or limiting demand peaks and making more favorable purchase plans of electric energy.

Most common forecast methods are based on machine learning (ML) techniques and require that relevant amounts of data are processed to provide accurate predictions. Additionally, these methods typically provide for carrying out a computationally intensive training phase of an artificial intelligence unit (e.g., a neural network) executing the ML algorithms.

ML-based prediction methods can thus be hardly implemented by computing systems typically managing the operation of field devices and switchboards in electric grids, which often have relatively limited storage and computational resources unsuitable to process huge amounts of data. These computing systems are, in fact, commonly based on Edge computing architectures and are basically aimed at bringing computation and data storage closer to the sources of data to improve response times and save bandwidth rather than processing large datasets.

In the state of the art, there have been developed prediction methods (e.g., based on linear regression analysis techniques), which normally require lighter computational and data storage resources compared to ML-based forecast methods and which would therefore be adapted for being implemented computing systems commonly used to manage electric grids.

An example of these prediction methods is described in U.S. Ser. No. 10/515,308B2.

However, available prediction methods of this type often provide relatively poor performances in terms of reliability and prediction accuracy compared to ML-based prediction techniques.

### BRIEF DESCRIPTION

The main task of the present disclosure is to provide to a method for predicting electric energy consumption in an electric grid, which can overcome the limitations of the prior art highlighted above.

Within this aim, another purpose of the present disclosure is to provide a prediction method, which can ensure high level performances in terms of reliability and prediction accuracy.

A further aim of the present disclosure is to provide a prediction method, which can be easily implemented even when limited computational and data storage resources are available and which is therefore suitable for being implemented in computing systems commonly used for managing the operation of electric grids, for example in computing systems based on Edge computing architectures.

This task and these aims, as well as other aims that will appear evident from the subsequent description and from the attached drawings, are achieved, according to the present disclosure, by a prediction method, according to claim 1 and to the related dependent claims proposed below.

In a general definition, the method, according to the present disclosure, comprises acquiring first detection data including detection values related to an actual electric energy consumption in said electric grid. The method additionally comprises acquiring additional detection data including detection values related to the energy consumption in said electric grid during at least a time window preceding a given reference instant, and acquiring calendar data including chronological information associated to the operation of said electric grid. The method further comprises calculating training data based on the acquired detection data and calendar data, and based on said training data, setting a linear auto-regressive mathematical model describing the trend of the electric energy consumption in said electric grid. Such a linear auto-regressive mathematical model is configured to process at least a set of exogenous input values indicative of at least a periodic function approximating the profile of the electric energy consumption in said electric grid over said at least a time window preceding said reference instant. Based on said linear auto-regressive model, the method further comprises calculating prediction data including prediction values related to the electric energy consumption in said electric grid during a time window following said reference instant.

In some embodiments, the method according to the present disclosure comprises acquiring second detection data including detection values related to the energy consumption in said electric grid during a first time window preceding said reference instant. In this case, the linear auto-regressive mathematical model is configured to process first exogenous input values indicative of a first periodic function approximating the profile of the electric energy consumption in said electric grid over said first time window.

In some embodiments, the method according to the present disclosure comprises also acquiring third detection data including detection values related to the energy consumption in said electric grid during a second time window preceding said reference instant. In this case, the linear auto-regressive mathematical model is configured to process second exogenous input values indicative of a second periodic function approximating the profile of the electric energy consumption in said electric grid over said second time window. In some embodiments, such a second time window is longer than said first time window.

### BRIEF DESCRIPTION OF DRAWINGS

Further characteristics and advantages of the present disclosure shall emerge more clearly from the description of preferred but not exclusive embodiments illustrated purely by way of example and without limitation in the attached drawings, in which:

FIG. 1 schematically illustrates a generic electric grid for electric power distribution applications; and

FIGS. 2-5 schematically illustrate the prediction method, according to the disclosure.

### DETAILED DESCRIPTION

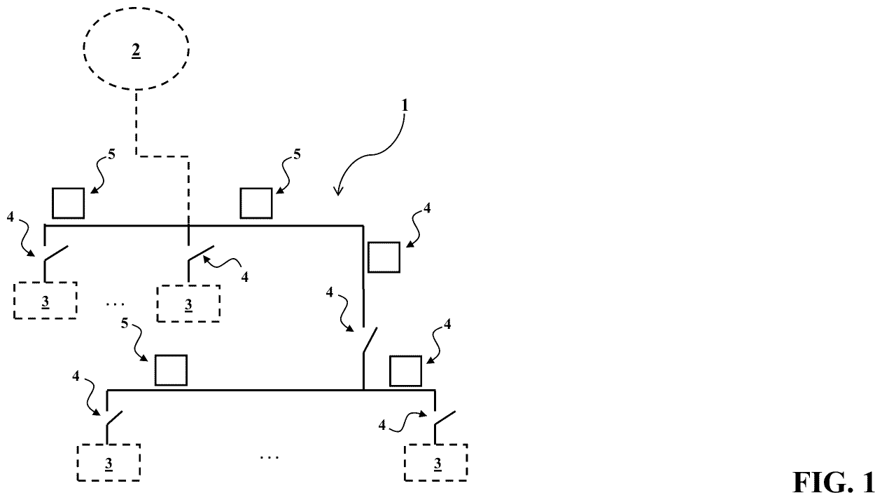

With reference to the mentioned figures, the present disclosure relates to a method 100 for predicting an electric energy consumption in an electric grid 1 (FIG. 1).

In principle, the electric grid 1 may be of any type, for example a smart grid, a micro-grid, or an electric power distribution network for industrial, commercial, or residential buildings or plants.

In some embodiments, the electric grid 1 operates at low or medium voltage levels, where the term “low voltage” relates to operational voltages up to 1.2 kV AC and 1.5 kV DC and the term “medium voltage” relates to operational voltages higher than 1.2 kV AC and 1.5 kV DC up to several tens of kV, e.g., up to 72 kV AC and 100 kV DC.

The electric grid 1 may be of the single-phase type or multiple-phase (e.g., three-phase) type. In general terms, the electric grid 1 can be electrically connected to one or more power sources 2 (e.g., an electric power utility) and to one or more electrical loads 3, each consuming a corresponding amount of electric energy in operation.

The electric grid 1 may comprise one or more field devices 4 (e.g., switching devices, sensors, and the like) configured to regulate the flow of electric power along the branches of the electric grid and one or more intelligent electronic devices 5 (e.g., controllers, protection relays, smart interfaces, and the like) configured to control the operation of the above-mentioned field devices and, more generally, of the electric grid.

Advantageously, the intelligent electronic devices 5 may be equipped with suitable computing and storage resources to process data related to the operation of the electric grid.

In some embodiment, the intelligent electronic devices 5 are based on Edge computing architectures.

In general, the above-mentioned electric grid 1, the power source 2, the electrical loads 3, the field devices 4 and intelligent electronic devices 5 may be of known type and will not be here further described in details for the sake of brevity.

The method 100, according to the present disclosure, is adapted for being executed by a computerized device. This latter may advantageously include data processing resources capable of executing software instructions configured to implement the method.

In some embodiments, such a computerized device is an intelligent electronic device 5 of the electric grid, which may be installed on the field as a self-standing device (e.g., a controller) or embedded in an electrical device 4 (e.g., as a protection relay). As an example, such an intelligent electronic device may be an intelligent switchboard HMI operatively coupled with a certain number of field devices 4 of the electric grid and configured to process data related to the operation of the electric grid.

As it will be better explained in the following, the method 100 provides for calculating prediction data D_{P} related to the electric energy consumption in the electric grid by using a special mathematical model M_{R}, which is cyclically set based on training data D_{T} calculated by collecting and processing detection data D_{S1}, D_{S2}, D_{S3} related to the real-time and historical electric energy consumption in the electric grid.

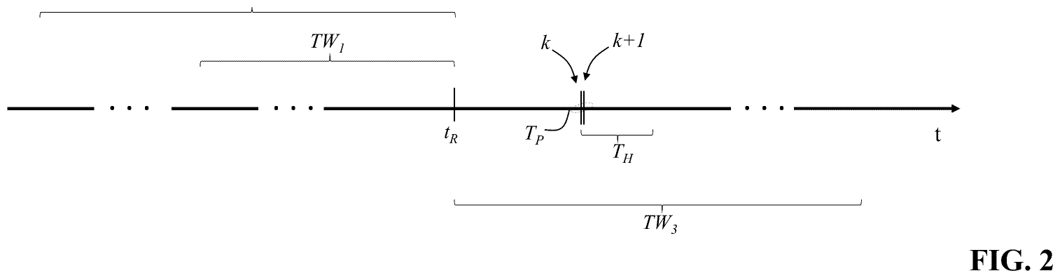

Referring to FIG. 2, the real time detection data D_{S1} are continuously acquired while historical detection data D_{S2}, D_{S3} are acquired at subsequent reference instants t_{R}, at which the above-mentioned mathematical model is set. The historical detection data D_{S2}, D_{S3} refer to different training time windows TW₁, TW₂ preceding the corresponding time reference instant t_{R} and have different selectable durations (e.g., some weeks or some months or years respectively).

Once it is set at the corresponding reference instant t_{R}, the set mathematical model M_{R} is used to calculate prediction data related to the future electric energy consumption in the electric grid during a prediction time-window TW₃ (e.g., a week) following the reference instant t_{R}.

During the above-mentioned prediction time window TW₃, the above-mentioned prediction data D_{P} are calculated periodically with a predefined time granularity T_{P} (e.g., 15 minutes) and with reference to a predefined time horizon T_{H} (e.g., 24 hours).

At the end of the prediction time-window TW₃, a new mathematical model is set at a new reference time instant and it is used to calculate the above-mentioned prediction data during a new prediction time window following said new reference instant.

The prediction method 100, according to the present disclosure, will now be described in details.

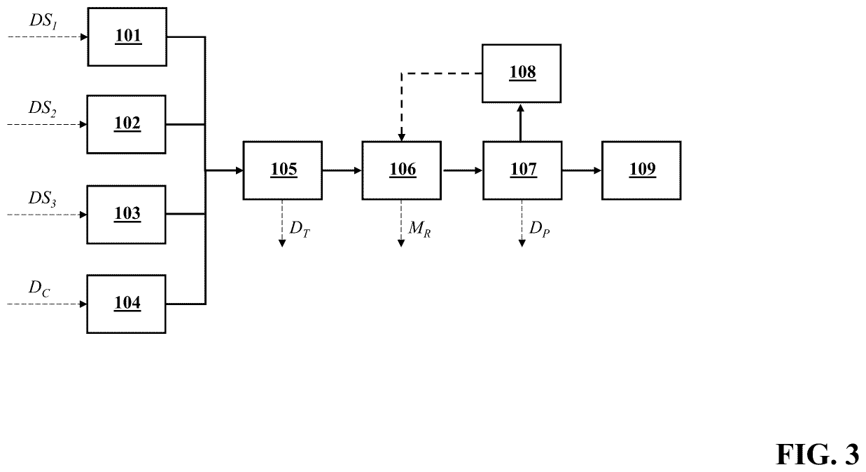

Referring to FIGS. 2-3, the method 100 comprises a step 101 of acquiring first detection data D_{S1} including detection values related to the actual (real-time) electric energy consumption in the electric grid.

The first detection data D_{S1} refer to the instantaneous energy consumption in the electric grid at each generic operation instant.

The first detection data D_{S1} may be collected from one or more field devices 4 (e.g., sensors) or from one or more intelligent electronic devices 5 installed on the field or even from remote computerized devices.

In some embodiments, the step 101 is continuously executed, possibly in parallel to other steps of the method 100. The first detection data D_{S1} thus include vectors of detection values, which are continuously and cyclically acquired and stored in a memory at subsequent acquisition instants, in which two consecutive acquisition instants are separated by a time interval corresponding to a predefined acquisition period of said first detection data.

According to the present disclosure, the prediction method 100 comprises one or more acquisition steps 102, 103, in which one or more sets of additional detection data D_{S2}, D_{S3} are acquired.

Each set of additional data includes detection values related to the historical energy consumption in the electric grid during a corresponding time window TW₁, TW₂ preceding a given reference instant t_{R}. As it is explained above, the time reference instant t_{R} is a time instant, at which a mathematical model M_{R} for calculating the prediction data D_{P} related to the future electric energy consumption in the electric grid is established.

According to some embodiments, the prediction method 100 comprises a step 102 of acquiring second detection data D_{S2} including detection values related to a historical electric energy consumption in the electric grid during a first time window TW₁ preceding the reference instant t_{R}.

The second detection data D_{S2} refer to the energy consumption in the electric grid at operation instants preceding the time reference instant t_{R} and included in the first time window TW₁.

The duration of the first time window TW₁ may be selected each time the above-mentioned mathematical model is established. As an example, the first time window TW₁ may refer to some weeks preceding the time reference instant t_{R}.

The second detection data D_{S2} may be acquired from a memory or from one or more intelligent electronic devices 5 installed on the field or even from remote computerized devices.

In some embodiments, the prediction method 100 comprises a step 103 of acquiring third detection data D_{S3} including detection values related to a historical electric energy consumption in the electric grid during a second time window TW₂ preceding the reference instant t_{R}.

The third detection data D_{S3} refer to the energy consumption in the electric grid at operation instants preceding the time reference instant t_{R} and included in the second time window TW₂.

In some embodiments, the duration of the second time window TW₂ is very longer than the duration of the first time window TW₁. As an example, the second time window TW₂ may refer to months or years preceding the time reference instant t_{R}.

The third detection data D_{S3} may be acquired from a memory or from one or more intelligent electronic devices 5 installed on the field or even from remote computerized devices.

According to the present disclosure, the prediction method 100 comprises a step 104 of acquiring calendar data Dc including chronological information associated to the operation of the electric grid. The calendar data Dc may include information related to working days, non-working days, or holidays or, more generally, other chronological circumstances, which may influence the energy power consumption in the electric grid.

The collected chronological information advantageously refers to a time window TW₃ following the reference instant t_{R}.

The calendar data Dc may be acquired from a memory or from one or more intelligent electronic devices 5 installed on the field or even from remote computerized devices.

According to the present disclosure, the prediction method 100 comprises a step 105 of calculating training data D_{T} by processing the acquired detection data and calendar data.

The training data D_{T} are intended to be used for setting a mathematical model describing the trend of the electric energy consumption in the electric grid during a third time window TW₃ following the reference instant t_{R}.

In principle, the duration of the third time window TW₃ may be varied each time the above-mentioned mathematical model is established. As an example, the third time window TW₃ may refer to a week following the time reference instant t_{R}.

In some embodiments, the calculation step 105 includes processing the first detection data D_{S1}, which are continuously acquired from outer data sources, to check the correctness of the acquired data. Advantageously, the first detection data D_{S1} are processed by means of suitable statistical techniques to identify outlier values or missing values. Possible incorrect detection values are conveniently replaced by using suitable interpolation techniques.

In some embodiments, the calculation step 105 includes processing the acquired second detection data D_{S2} to identify the trend of the electric energy consumption in the electric grid during the first time window TW₁. In practice, the acquired second detection data D_{S2} are analyzed through suitable statistic techniques to identify a short-term behavior of the electric energy consumption in the electric grid before the reference instant t_{R}.

As it will be more apparent from the following, the information obtained through this processing activity are conveniently used to calculate a first periodic function U(t) describing the profile of the electric energy consumption in the electric grid over the first time window W_{T1}.

This allows setting the above-mentioned mathematical model M_{R} in such a way to consider possible short-term non-linearities influencing the electric energy consumption in the electric grid.

The information obtained through this processing activity may be also used to tune appropriately the duration of the first time window TW₁.

As an example, the first time window TW₁ may be tuned at two weeks or four weeks preceding the reference instant t_{R}, if the detected electric energy consumption shows a high level of periodicity or a less regular profile, respectively.

Advantageously, the duration of the first time window TW₁ may be tuned depending also on the chronological information referring to said time window, which may be advantageously derived from the acquired calendar data Dc.

In some embodiments, the calculation step 105 includes processing the acquired third detection data D_{S3} to identify the trend of the electric energy consumption in the electric grid during the second time window TW₂. In practice, the acquired third detection data D_{S2} are analyzed through suitable statistic techniques to identify a long-term trend (or seasonality) of the electric energy consumption in the electric grid before the reference instant t_{R}. This would not be possible, if only the historical detection data related to the first time window TW₁ were considered.

As it will be more apparent from the following, the information obtained through this processing activity are conveniently used to calculate a second periodic function Uₗ(t) describing the profile of the electric energy consumption in the electric grid over the second time window TW₂.

This allows setting the above-mentioned mathematical model in such a way to consider possible long-term non-linearities or seasonal factors influencing the electric energy consumption in the electric grid.

According to the present disclosure, the prediction method 100 comprises a step 106 of setting a linear auto-regressive mathematical model M_{R} based on the calculated training data D_{T}.

The mathematical model M_{R} describes the trend of the electric energy consumption in the electric grid and it is intended to be used for calculating the prediction data D_{P} related to the electric energy consumption at instants following the reference instant t_{R}, particularly at subsequent instants k included in the electric grid during the third time window TW₃.

As it has an auto-regressive nature, at each instant k+1, the mathematical model M_{R} is configured to process endogenous input values y(k) referred to a preceding instant k.

The endogenous input values y(k) include previously calculated prediction values related to electric energy consumption in the electric grid and, possibly, also previously acquired detection values related to the instantaneous electric energy consumption in the electric grid, which are included in the first detection data D_{S1}.

According to a particularly important aspect of the present disclosure, however, the mathematical model M_{R} is configured to process one or more sets of exogenous input values U(k), Uₗ(k).

Each set of exogenous input values is indicative of a corresponding periodic function U(t), Uₗ(t) approximating the profile of the electric energy consumption in the electric grid over a corresponding time window TW₁, TW₂ preceding the reference instant t_{R}.

In some embodiments, the linear auto-regressive model M_{R} is configured to process first exogenous input values U(k) referred to an instant k preceding the reference instant t_{R}.

The first exogenous input values U(k) are indicative of a first periodic function U(t) approximating the profile of the electric energy consumption in the electric grid over the first time window TW₁.

In some embodiments, the first periodic function U(t) is a combination of cosine and sine functions having unitary amplitude and different frequencies, for example ranging from hourly values to weekly values. Advantageously, the first periodic function U(t) is calculated based on training data obtained by processing the acquired second detection data D_{S2} to identify the trend of the electric energy consumption in the electric grid during the first time window TW₁.

A vector of first exogenous input values U(k) at a generic instant k preceding the reference instant t_{R} may thus be expressed as the combination of n sinusoidal terms according to the following expression:

U(k)=[cos(w₁k), . . . ,cos(wₙk), sin(w₁k), . . . , sin(wₙk)]

where the terms, w₁, . . . , wₙ are indicative of the frequencies selected to approximate the profile of the electric energy consumption over the first time window TW₁.

In some embodiments, the linear auto-regressive model M_{R} is configured to process second exogenous input values Uₗ(k) referred to an instant k preceding the reference instant t_{R}.

The second exogenous input values Uₗ(k) are indicative of a second periodic function U_{L}(t) approximating the profile of the electric energy consumption in the electric grid over the second time window TW₂.

In some embodiments, the second periodic function Uₗ(t) is a combination of cosine and sine functions having unitary amplitude and different frequencies, for example ranging from monthly values to yearly values.

Advantageously, the second periodic function Uₗ(t) is calculated based on training data obtained by processing the acquired third detection data D_{S3} to identify the trend of the electric energy consumption in the electric grid during the second time window TW₂.

A vector of second exogenous input values Uₗ(k) at a generic instant k preceding the reference instant t_{R} may thus be expressed as the combination of q sinusoidal terms according to the following expression:

Uₗ(k)=[cos(w₁k), . . . ,cos(w_{q}k), sin(w₁k), . . . , sin(w_{q}k)]

where the terms, w₁, . . . , w_{q} are indicative of the frequencies selected to approximate the profile of the electric energy consumption over the second time window TW₂.

The setting of the mathematical model M_{R} is conveniently carried out during a training phase, which may include one or more training steps.

At each training event, the parameters θ of the mathematical model are iteratively calculated until a maximum number of training steps is reached or the estimated error of the calculated prediction values is sufficiently low.

The step 106 of setting the mathematical model M_{R} conveniently comprises setting the auto-regressive order m of said mathematical model and setting the maximum number Tₘₐₓ of training steps for training said mathematical model.

The autoregressive order m is a parameter that may be selected depending on the desired model complexity level, or the length of the considered time windows TWᵢ, or based on a cross-validation phase performed before the implementation of the described approach, for example on a different dataset D_{S0}, if available.

As an example, the autoregressive order m may be set as m=3.

The maximum number Tₘₐₓ of training steps is a parameter that may be selected depending for example on the performance of the available edge computing unit, or on possible time constraints of the considered application.

In some embodiments, the number of training events is T>1. In this case, two following training events are advantageously separated by a time interval, which is relatively long compared to the time granularity set for calculating the prediction data D_{P}. For example, if a time granularity of 15 minutes is set, the time interval between two subsequent training events may be 24 hours.

In some embodiments, the linear auto-regressive mathematical model M_{R} is a linear ARX mathematical model with one or more exogenous inputs.

In general terms, the mathematical model M_{R} may thus be expressed as:

$$y ( k + 1 ) = {φ ( k )}^{T} * θ = [ {y ( k )}^{T} {U ( k )}^{T} {{U}_{l} ( k )}^{T} ] * θ , with k = m + 1 , … , {T}_{H} / {T}_{P} .$$

where:
y(k) is a vector of endogenous input values. For k<=2m, y(k) includes both previously calculated prediction values and real-time detection values included in the first detection data D_{S1} while y(k) includes only previously calculated prediction values for k>2m;
U(k) is a vector of first exogenous input values indicative of a first periodic function U(t) approximating the profile of the electric energy consumption in the electric grid over the first time window TW₁;
Uₗ(k) is a vector of second exogenous input values indicative of a second periodic function U_{L}(t) approximating the profile of the electric energy consumption in the electric grid over the second time window TW₂;
θ is a vector of model parameters to be calculated during the training phase of the mathematical model;
T_{H} is the time horizon set for calculating the prediction data D_{P}. As an example, T_{H} may be set as T_{H}=24 hours;
T_{P} is the time granularity set for calculating the prediction data D_{P}. As an example, T_{P} may be set as T_{P}=15 minutes.
The ratio T_{H}/T_{P} defines the number of prediction and detection values to be considered for calculating the prediction error. As an example, the ratio takes a value T_{H}/T_{P}=96 with a time horizon T_{H} set at 24 hours and a time granularity T_{P} set at 15 minutes.

At each training event, a preliminary vector 9′ of model parameters is calculated by solving the unconstrained linear problem:

$${θ}^{′} = arg {min}_{{θ}^{′}} {\sum }_{i = 1}^{T} {‖ {A}_{i} - {Y}_{i} ‖}^{2}$$

where:
T is the number representing the elapsed time (in some embodiments counted in days) up to the training event and during which the first detection data D_{S1} have been collected;
Ai is a vector of (T_{H}/T_{P}−m) detection values included in a time unit i (in some embodiments a day i), during which the first detection data D_{S1} have been collected, where m is the set number of regression steps. As an example, the vector Ai has (96−m) values with a time horizon T_{H} set at 24 hours and a time granularity T_{P} set at 15 minutes;
Yi is a vector of (T_{H}/T_{P}−m) prediction values calculated for a time unit i (in some embodiments a day i), during which the detection data D_{S1} have been collected. As an example, the vector Yi has (96−m) values with a time horizon T_{H} set at 24 hours and a time granularity T_{P} set at 15 minutes.

The training phase of the mathematical model M_{R} is terminated if the maximum number of training steps Tₘₐₓ is achieved or the calculated error∥ Aᵢ−Yᵢ∥ is lower than a predefined threshold.

At the end of the training phase, the last calculated vector θ′ of model parameters becomes the final vector θ of model parameters of the mathematical model. The mathematical model M_{R} is thus finally set.

The final vector of model parameters θ may be expressed as:

θ=[θ_{y},θ_{U},θ_{Ul}]

where:
θ_{y} is a vector of calculated model parameters linearly combining the endogenous input values input y(k);
θ_{U} is a vector of calculated model parameters linearly combining the first exogenous input values input U(k);
θ_{Ul} is a vector of calculated model parameters linearly combining the second exogenous input values input Uₗ(k).

According to an aspect of the present disclosure, one or more final parameters of the mathematical model M_{R} are tuned based on previously calculated corresponding parameters of the mathematical model.

In particular, the final model parameters θ_{Ul} combining the second exogenous input values input Uₗ(k) may be calculated based on corresponding parameters θ′_{Ul} calculated during the training phase and previously calculated corresponding parameters θ″_{Ul} (i.e., corresponding parameters of previously set mathematical models, which were obtained during previous training events).

The vector θ_{Ul} of final model parameters combining the second exogenous input values input Uₗ(k) may be calculated as:

$${θ}_{Ul} = ( 1 - α ) * {{θ}^{′}}_{U l} + α * {{θ}^{″}}_{U l}$$

where:
θ′_{Ul} is a vector of corresponding parameters calculated during the latest training event;
θ″_{Ul} is a vector of corresponding parameters calculated during a previous training event;
α is a tunable parameter, with 0<α<=1.

The tunable parameter α allows tuning the speed of adaptation of the input values (second exogenous input values), which are adapted to consider a long-term seasonality of the electric energy consumption, on the acquired detection values indicative of the instantaneous electric energy consumption of the electric grid.

A larger value of a provides a slower adaptation as more weight is given to the contribution of the parameters calculated during preceding training events while a smaller value of a provides a faster adaptation as more weight is given to the contribution of the parameter set during the latest training event.

According to the present disclosure, the prediction method 100 comprises a step 107 of calculating the prediction data D_{P} based on the mathematical model M_{R} set at the preceding steps 106.

The prediction data D_{P} include prediction values related to the electric energy consumption in the electric grid during the third time window TW₃.

As shown above, the prediction data D_{P} are cyclically calculated at subsequent calculation instants k with a predefined time granularity T_{P} (e.g, 15 minutes).

In some embodiments, at each calculation instant k, the prediction data D_{P} are calculated with a predefined time horizon T_{H} (e.g, 24 hours).

In some embodiments, the prediction method 100 is cyclically repeated as described above at the end of each third time window TW₃.

When third time window T_{w3} expires, a new linear auto-regressive mathematical M_{R} model is set at a new reference instant t_{R}.

The above-described steps 102-106 of the method 100 are thus repeated with reference to new time windows TW₁, TW₂ and TW₃ calculated based on the new reference instant t_{R} while the above-mentioned first detection data D_{S1} are continuously acquired (step 101 of the method 100) at each acquisition period.

The newly set mathematical model M_{R} is then used to calculate prediction values related to the electric energy consumption in the electric grid during a new time window TW₃ following the new reference instant t_{R}.

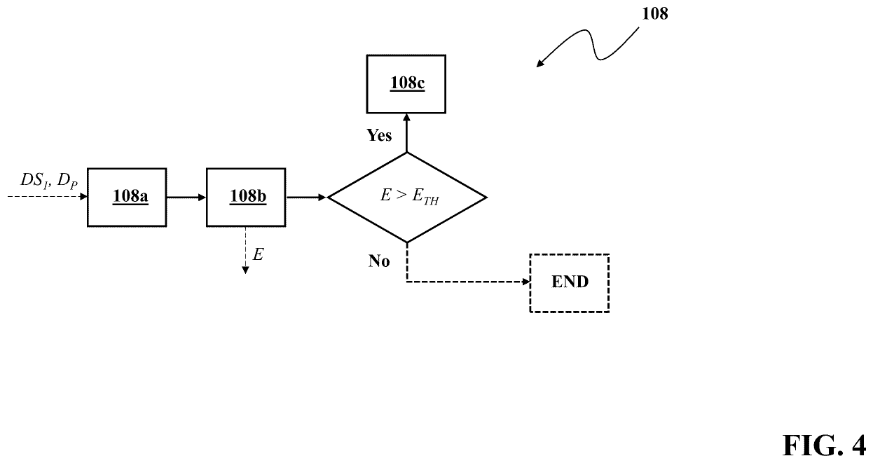

According to an aspect of the present disclosure (FIGS. 3-4), the method 100 comprises a step 108 of carrying out a first check procedure to check the computational performances of the mathematical model M_{R} established at the reference instant t_{R}.

The first check procedure 108 is aimed at checking whether the prediction data D_{P} calculated by the mathematical model M_{R} match with corresponding detection data D_{S1} indicative of the actual electric energy consumption in the electric grid.

In some embodiments, the first check procedure 108 comprises a step 108a of comparing the first detection data D_{S1} and the prediction data D_{P}, which have respectively been acquired and calculated in a time interval (checking period) between the last execution instant of the first check procedure 108 (or the reference instant t_{R} if the check procedure is executed for the first time) and the current execution instant of the check procedure.

In some embodiments, the first check procedure 108 comprises a step 108b of calculating an error function

E indicative of differences between the detection values included in the collected first detection data D_{S1} and the prediction values included in the calculated prediction data D_{P}.

The error function E, which may be for example a MAPE error function, provides a measure of prediction accuracy ensured by the mathematical model M_{R} while calculating the prediction data D_{P}.

The check procedure 108 includes a step 108c of updating the mathematical model M_{R}, if the above-mentioned error function E takes values exceeding a threshold error value E_{TH}.

The updating of the mathematical model M_{R} is carrying out by newly executing the step 106 of the method 100, as described above. In practice, the mathematical model M_{R} is updated by forcing a new training event to be carried out as described above.

If the above-mentioned error function E takes values, which do not exceed the threshold error value E_{TH}, the mathematical model M_{R} is maintained and the first check procedure 108 is terminated.

In some embodiments, the first check procedure 108 is carried out cyclically during the third time window T_{W3}, for example with a checking period of 24 hours.

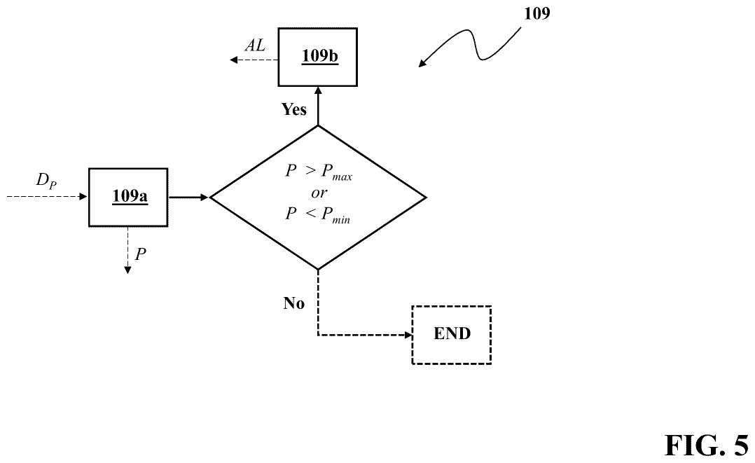

According to another aspect of the present disclosure (FIGS. 3 and 5), the method 100 comprises a step 109 of carrying out a second check procedure to check the predicted electric energy consumption in the electric grid.

The first check procedure 108 is aimed at checking whether the prediction data D_{P} calculated by the mathematical model M_{R} falls within a confidence band of prediction.

In some embodiments, the second check procedure 109 comprises a step 109a of processing the calculated prediction data D_{P} to calculate a prediction function P indicative of a predicted trend of the electric energy consumption in the electric grid.

In order to calculate the prediction function P, the calculated prediction data D_{P} may be processed by means of suitable statistical techniques of known type.

In some embodiments, the second check procedure 109 comprises a step 109b of generating an alert signal AL, if the prediction function P takes values higher than a predefined maximum confidence value P_{Max} or lower than a predefined minimum confidence value P_{Min}.

The confidence values Pₘₐₓ, Pₘᵢₙ may be conveniently calculated by calculating an error function indicative of differences between the detection values included in the collected first detection data D_{S1} and the prediction values included in the calculated prediction data D_{P} and processing said error function by means of suitable statistical techniques of known type.

If the above-mentioned prediction function P takes values within the confidence band defined by the confidence values Pₘₐₓ, Pₘᵢₙ, the second check procedure 109 is terminated.

In some embodiments, the second check procedure 109 is carried out cyclically during the third time window T_{W3}, for example with a repetition period of 24 hours.

The prediction method 100, according to the present disclosure, provides relevant advantages.

The prediction method 100 ensure high level performances in terms of prediction accuracy:

The circumstance that the linear auto-regressive model M_{R} is configured to process both first and second exogenous input values U(k), Uₗ(k) is particularly relevant from this point of view. This solution, in fact, allows remarkably improving the prediction accuracy as short-term and long-term factors, which may influence the trend of the electric energy consumption, are duly considered while calculating the prediction data D_{P}.

The fine tuning of the model parameters θ carried out after the completion of the training phase, particularly of the parameters θ_{Ul} intended to model the long-term seasonality of the electric energy consumption, further improves the performances provided by the prediction method 100.

The iterative checking of the accuracy of the calculated prediction data further improves the reliability of the prediction method.

In confirmation of the above, experimental tests have shown that the prediction method 100 ensures accuracy performances fully comparable with the accuracy performances provided by the known methods of the state of the art based on ML algorithms.

The prediction method 100 is configured to process relatively small sets of data. Therefore, it is particularly adapted for being implemented in computing systems having limited computational and data storage resources, for example in Edge computing systems commonly-used for managing the operation of electric grids.

The prediction method 100 is thus particularly adapted to be implemented using the hardware and software resources already installed on the field to manage the operation of an electric grid.

The prediction method 100 is thus adapted for being implemented in digitally enabled power distribution networks (smart grids, micro-grids and the like).

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for predicting electric energy consumption in an electric grid, said method comprising:
acquiring first detection data including detection values related to an actual electric energy consumption in said electric grid;
acquiring additional detection data including detection values related to the energy consumption in said electric grid during at least a time window preceding a reference instant;
acquiring calendar data including chronological information associated to the operation of said electric grid;
calculating training data based on the acquired detection data and calendar data;
based on said training data, setting a linear auto-regressive mathematical model describing the trend of the electric energy consumption in said electric grid, said linear auto-regressive mathematical model being configured to process at least a set of exogenous input values indicative of at least a periodic function approximating the profile of the electric energy consumption in said electric grid over said at least a time window preceding said reference instant; and
based on said linear auto-regressive model, calculating prediction data including prediction values related to the electric energy consumption in said electric grid during a time window following said reference instant.

2. The method, according to claim 1, the method further comprising acquiring second detection data including detection values related to the energy consumption in said electric grid during a first time window preceding said reference instant,
wherein said linear auto-regressive mathematical model is configured to process first exogenous input values indicative of a first periodic function approximating the profile of the electric energy consumption in said electric grid over said first time window.

3. The method, according to claim 1, the method further comprising acquiring third detection data including detection values related to the energy consumption in said electric grid during a second time window preceding said reference instant,
wherein said linear auto-regressive mathematical model is configured to process second exogenous input values indicative of a second periodic function approximating the profile of the electric energy consumption in said electric grid over said second time window.

4. The method, according to claim 1, wherein calculating said training data includes processing the acquired first detection data to check the correctness of said data.

5. The method, according to claim 2, wherein calculating said training data includes processing the acquired second detection data to identify the trend of the electric energy consumption in the electric grid during the first time window.

6. The method, according to claim 3, wherein calculating said training data includes processing the acquired third detection data to identify the trend of the electric energy consumption in the electric grid during the second time window.

7. The method, according to claim 1, wherein said prediction data are cyclically calculated with a predefined time granularity and with a predefined time horizon.

8. The method, according to claim 1, wherein said linear auto-regressive mathematical model is a linear ARX mathematical model with one or more exogenous inputs.

9. The method, according to claim 1, wherein setting said linear auto-regressive mathematical model includes:
setting a regression order and a maximum number of training steps for said linear auto-regressive mathematical model; and
iteratively calculating one or more parameters of said linear auto-regressive mathematical model based on said training data during said training steps by solving an unconstrained linear problem established basing on the set regression order and maximum number of training steps.

10. The method, according to claim 1, wherein setting said linear auto-regressive mathematical model includes tuning one or more parameters of said linear auto-regressive model based on corresponding parameters calculated during said training steps and one or more parameters calculated for previously set linear auto-regressive mathematical models.

11. The method, according to claim 1, comprising carrying out a first check procedure to check the computational performances of said mathematical model.

12. The method, according to claim 11, wherein said first check procedure comprises:
comparing the first detection data acquired during a predefined checking period and the prediction data calculated during said checking interval;
calculating an error function indicative of differences between the detection values included in said first detection data and the prediction values included in said prediction data; and
updating said auto-regressive mathematical model, if said error function takes values exceeding a threshold error value.

13. The method, according to claim 1, comprising carrying out a second check procedure to check the electric energy consumption predicted by said mathematical model.

14. The method, according to claim 13, wherein said second check procedure comprises:
processing the calculated prediction data to calculate a prediction function indicative of a predicted trend of the electric energy consumption in said electric grid;
generating an alert signal, if said prediction function takes values higher a maximum confidence value or lower than a minimum confidence value.

15. A computer program, which is stored or storable in a non-transitory computer-readable storage medium, wherein it comprises software instructions to implement the method, according to claim 1.

16. A computerized device comprising data processing resources configured to execute software instructions to implement the method, according to claim 1.

17. The computerized device, according to claim 16, wherein it is an intelligent electronic device configured to manage operations of an electric power distribution grid.
